(19) United States
(12) Patent Application Publication
(10) Pub. No.: US 2026/0311348 A1
(43) Pub. Date: Oct. 8, 2026

(54) METHOD AND APPARATUS FOR DETERMINING TEXT TRACK IN VIDEO, AND DEVICE, AND MEDIUM

(71) Applicant: Douyin Vision Co., Ltd., Beijing (CN)

(72) Inventors: Han WANG, Beijing (CN); Yanjie WANG, Beijing (CN); Yang LI, Beijing (CN); Can HUANG, Beijing (CN)

(21) Appl. No.: 19/483,374

(22) PCT Filed: May 9, 2024
(86) PCT No.: PCT/CN2024/092067

§ 371 Date: Nov. 11, 2025

(30) Foreign Application Priority Data
May 18, 2023 (CN) 202310563293.3

(51) Int. Cl. G06T 7/246; G06V 10/26; G06V 10/74; G06V 10/75; G06V 10/774; G06V 10/82; G06V 20/40; G06V 20/62; G06V 30/148; G06V 30/18; G06V 30/19

(52) U.S. Cl. CPC G06T 7/248; G06V 10/26; G06V 10/751; G06V 10/759; G06V 10/761; G06V 10/774; G06V 10/82; G06V 20/46; G06V 20/63; G06V 30/148; G06V 30/18; G06V 30/19147; G06T 2207/10016; G06T 2207/20081; G06T 2207/20084; G06T 2207/30241

(57) ABSTRACT

Embodiments of the present disclosure relate to a method for determining a trajectory of a text in a video, the method includes determining a first feature set corresponding to a first text set and a second feature set corresponding to a second text set, the first text set being located in a target frame of the video, the second text set being located in a plurality of frames before the target frame in the video, and texts in the second text set being associated with a text trajectory in a text trajectory set. The method also includes determining a degree of association set based on the first feature set and the second feature set, the degree of association in the degree of association set indicating a probability of a text in the first text set being on the text trajectory in the text trajectory set.

### CROSS-REFERENCE TO RELATED APPLICATION(S)

The present application claims priority to Chinese Patent Application No. 202310563293.3, filed on May 18, 2023, and entitled “METHOD AND APPARATUS FOR DETERMINING TEXT TRACK IN VIDEO, AND DEVICE, AND MEDIUM”, which is incorporated herein by reference in its entirety.

### TECHNICAL FIELD

Embodiments of the present disclosure generally relate to the field of video processing, and in particular, to a method, an apparatus, a device and a medium for determining a trajectory of a text in a video.

### BACKGROUND

With the rapid development of computer technologies and the wide application of video files, the detection of information in videos becomes more and more important. For example, detecting a person, a text, etc. in a video. In order to facilitate in-depth analysis of a video, video text detection has become an important development direction in video detection. Video text detection is mainly for locating and tracking text instances in a video. By locating and tracking texts in a video, the video has greater application prospects in video analysis and multimedia information retrieval. Although great efforts have been made in both text detection and tracking, there are still many problems to be solved due to the detection of texts in a video being affected by various factors.

### SUMMARY

Embodiments of the present disclosure provide a method, an apparatus, a device and a medium for determining a trajectory of a text in a video.

According to a first aspect of the present disclosure, a method for determining a trajectory of a text in a video is provided. The method includes determining a first feature set corresponding to a first text set and a second feature set corresponding to a second text set, the first text set being located in a target frame of the video, the second text set being located in a plurality of frames before the target frame in the video, and texts in the second text set being associated with a text trajectory in a text trajectory set. The method further includes determining a degree of association set based on the first feature set and the second feature set, a degree of association in the degree of association set indicating a probability of a text in the first text set being on the text trajectory in the text trajectory set. The method further includes determining a text trajectory corresponding to a text in the first text set based on the degree of association set.

In a second aspect of the present disclosure, an apparatus for determining a trajectory of a text in a video is provided. The apparatus includes a feature set determination module configured to determine a first feature set corresponding to a first text set and a second feature set corresponding to a second text set, the first text set being located in a target frame of the video, the second text set being located in a plurality of frames before the target frame in the video, and texts in the second text set being associated with a text trajectory in a text trajectory set; a degree of association set determination module configured to determine a degree of association set based on the first feature set and the second feature set, a degree of association in the degree of association set indicating a probability of a text in the first text set being on the text trajectory in the text trajectory set; and a target text trajectory determination module configured to determine a text trajectory corresponding to a text in the first text set based on the degree of association set.

In a third aspect of the present disclosure, an electronic device is provided, including at least one processor; and a storage device for storing at least one program, where the at least one program, when executed by the at least one processor, causes the at least one processor to implement the method according to the first aspect of the present disclosure.

In a fourth aspect of the present disclosure, a computer-readable storage medium is provided, on which a computer program is stored, where the program, when executed by a processor, implements the method according to the first aspect of the present disclosure.

It should be understood that the content described in this section is not intended to limit the key or important features of the embodiments of the present disclosure, nor is it intended to limit the scope of the present disclosure. Other features of the present disclosure will become readily apparent from the following description.

### BRIEF DESCRIPTION OF THE DRAWINGS

The above and other objects, features and advantages of the present disclosure will become more apparent from the following description of exemplary embodiments of the present disclosure in conjunction with the drawings, in which the same reference numbers generally represent the same parts in the exemplary embodiments of the present disclosure.

FIG. 1 illustrates a schematic diagram of an example environment in which a device and/or a method of an embodiment of the present disclosure may be implemented;

FIG. 2 illustrates a schematic diagram of an example of detecting a text trajectory according to an embodiment of the present disclosure;

FIG. 3 illustrates a schematic diagram of an example method for determining a trajectory of a text in a video according to an embodiment of the present disclosure;

FIG. 4 illustrates a schematic diagram of an example framework for determining a trajectory of a text in a video according to an embodiment of the present disclosure;

FIG. 5A-FIG. 5C illustrate schematic diagrams of three examples of detecting similarity of text boxes according to an embodiment of the present disclosure;

FIG. 6 illustrates a schematic diagram of an example recognition result of a video text according to an embodiment of the present disclosure;

FIG. 7 illustrates a schematic diagram of an example recognition result of a video text according to an embodiment of the present disclosure;

FIG. 8 illustrates a schematic block diagram of an apparatus for determining a trajectory of a text in a video according to an embodiment of the present disclosure;

FIG. 9 illustrates a schematic block diagram of an example device suitable for implementing an embodiment of the present disclosure.

In the various drawings, the same or corresponding reference numbers refer to the same or corresponding parts.

### DETAILED DESCRIPTION OF EMBODIMENTS

It should be understood that the data involved in the technical solution of the present disclosure (including but not limited to the data itself, the acquisition or use of the data) should comply with the requirements of corresponding laws, regulations and related provisions. In response to receiving an active request from a user, the user is sent prompt information to explicitly prompt the user that the operation requested to be performed will need to acquire and use the user's personal information. Thus, the user can autonomously select whether to provide the personal information to software or hardware that performs the operation of the technical solution of the present disclosure, such as an electronic device, an application, a server, or a storage medium, according to the prompt information.

The embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein; rather, these embodiments are provided for a more thorough and complete understanding of the present disclosure. It should be understood that the drawings and embodiments of the present disclosure are only for illustrative purposes, and are not intended to limit the scope of protection of the present disclosure.

In the description of the embodiments of the present disclosure, the term “include/comprise” and similar expressions should be understood as open-ended inclusions, that is, “include/comprise but not limited to”. The term “based on” should be understood as “at least partially based on”. The term “an embodiment” or “the embodiment” should be understood as “at least one embodiment”. The terms “first”, “second”, etc. may refer to different or same objects. Other explicit and implicit definitions may also be included below.

As mentioned above, there are still many technical problems to be solved in terms of text detection and tracking of video texts. In order to better recognize text content in a video, some methods for recognizing texts in a video are proposed in a conventional solution. For example, in some conventional solutions, a text in a to-be-recognized video frame in a video is compared with a text in a recognized video frame, to determine whether the text in the to-be-recognized video frame corresponds to a text in the recognized video frame. If a corresponding text is found, a trajectory of the text in the to-be-processed video frame is determined according to a trajectory of the text in the recognized video frame. The text content of the text is also recognized in this process. However, this conventional solution only uses comparison between two frames to determine the trajectory and content of the text. However, this manner has the problem of inaccurate recognition of the trajectory of the text, for example, a text in a to-be-processed video corresponds to an incorrect text in a marked video frame, causing the trajectory of the text to switch. Further, since this conventional manner couples text recognition and trajectory determination together, this will also lead to inaccurate text recognition.

At least to solve the above and other potential problems, embodiments of the present disclosure propose a method for determining a trajectory of a text in a video. In this method, a computing device first determines a first feature set corresponding to a first text set and a second feature set corresponding to a second text set. Wherein the first text set is located in a target frame of the video, the second text set is located in a plurality of frames before the target frame in the video, and texts in the second text set are associated with a text trajectory in a text trajectory set. The computing device also determines a degree of association set according to the first feature set and the second feature set, the degree of association in the degree of association set indicating a probability of a text in the first text set being on the text trajectory in the text trajectory set. Through the degree of association set, the computing device can determine a text trajectory corresponding to the text in the first text set. Through this method, because of using historical information in the video, the accuracy of text trajectory recognition is improved and the text trajectory switching occurred in the recognition process is reduced. In a further improvement, the solution also introduces the similarity of text bounding boxes in two adjacent frames, making the text trajectory prediction more accurate. Moreover, in this solution, text recognition and trajectory prediction are processed separately, making text recognition more comprehensive and improving user experience.

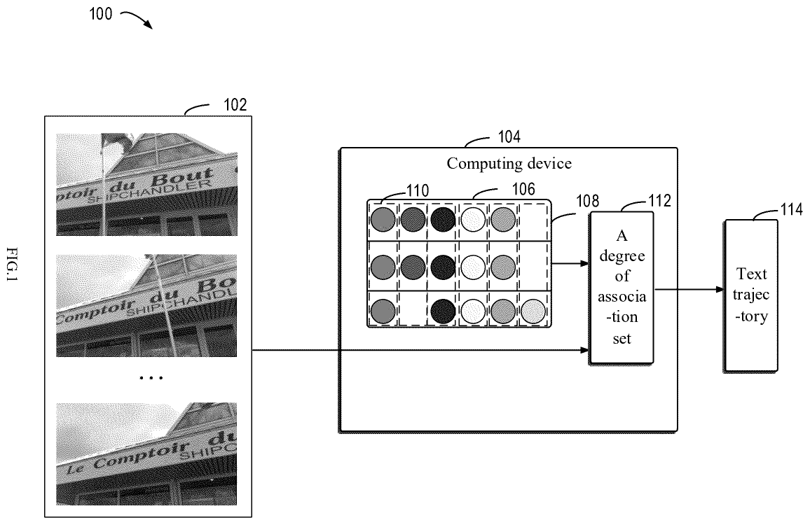

The embodiments of the present disclosure will be further described in detail below with reference to the drawings. FIG. 1 illustrates an example environment in which a device and/or a method of an embodiment of the present disclosure may be implemented. In the environment 100, the computing device 104 is configured to process the video 102 to determine a text trajectory 114 of a text in the video.

Examples of the computing device 104 include but are not limited to a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, the video 102 includes a plurality of consecutive video frames, and there is a recognizable text in the video frame. The number of video frames included in the video 102 may be set by a user as needed. FIG. 1 shows that the computing device 104 receives the video 102, for example, receives the video 102 from another computing device or a remote storage device in a network, which is only an example, and is not a specific limitation of the present disclosure. The computing device 104 may also obtain the video 102 from a local storage device.

After receiving the video 102, the computing device 104 will process the video 102. In the processing process, the computing device 104 will determine a text trajectory formed by texts in the video frames in the video 102. Additionally, the computing device 102 will also recognize the text content in the video frame to generate a corresponding text.

When processing the video 102, the computing device 104 will use features of texts in video frames that have been processed to form a global feature pool 106 for the video 102. The global feature pool 106 stores features of texts in each processed video frame, such as embedding vector representations of texts. The computing device 104 also stores features of one or more texts in one video frame in association, as shown by a row 108, which represents that the features of one or more texts recognized in one video frame are stored. Additionally, after processing the video frames, the computing device 104 will also use positions of a same text in different frames in the video frame to generate a text trajectory, and store text features with the same trajectory in a plurality of frames in association, for example, assign a corresponding trajectory identification to each text feature, for example, the features in the box 110 are features with the same trajectory. Therefore, there is a text trajectory set corresponding to the text features in the global feature pool in the computing device.

When processing the first frame of the video 102, the computing device assigns a trajectory identification to each recognized text in the first frame. When processing subsequent frames, the computing device uses a first feature set of texts in a to-be-processed frame and a second feature set formed by features in the global feature pool 106 to determine a degree of association set 112 indicating a probability of a text in the first text set being on the text trajectory in the text trajectory set. After obtaining the degree of association set 112, the computing device uses the degree of association set to determine a text trajectory 114 corresponding to the text in the first text set.

Through this method, because of using historical information in the video, the accuracy of text trajectory recognition is improved and the text trajectory switching occurred in the recognition process is reduced, improving user experience.

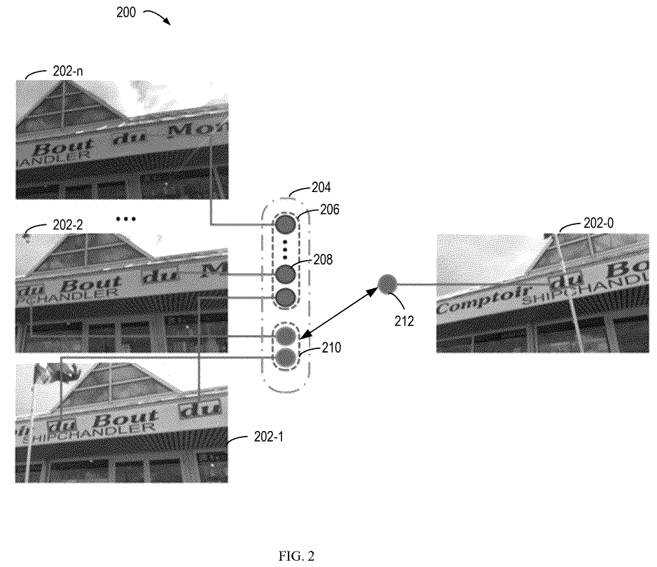

The above describes the schematic diagram of the example environment in which the device and/or the method of the embodiment of the present disclosure may be implemented with reference to FIG. 1, and the following describes the schematic diagram of the example of detecting a text trajectory according to the embodiment of the present disclosure with reference to FIG. 2.

As shown in FIG. 2, in the example 200, the computing device processes a video, for example, video frames 202-1, 202-2, . . . , 202-n in the video have been processed, and a global feature pool 204 is generated, and the feature pool 204 includes two text trajectories 206 and 210. Each trajectory has a corresponding feature of a text, such as the feature 208. For a to-be-processed video frame 202-0 in the video, a feature 212 of a text is determined. By using the method of the present disclosure, it is determined that the text has a corresponding trajectory 210.

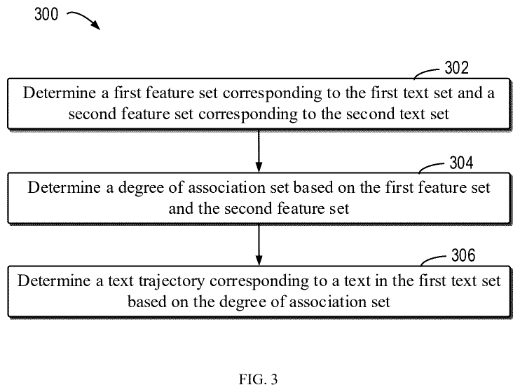

The above describes the schematic diagram of the example of detecting a text trajectory according to the embodiment of the present disclosure with reference to FIG. 2. The following describes the schematic diagram of the example method for determining a trajectory of a text in a video according to the embodiment of the present disclosure with reference to FIG. 3. The process shown in FIG. 3 may be performed at the computing device 104 shown in FIG. 1 or any other suitable computing device.

At block 302, a first feature set corresponding to a first text set and a second feature set corresponding to a second text set are determined, the first text set being located in a target frame of the video, the second text set being located in a plurality of frames before the target frame in the video, and texts in the second text set being associated with a text trajectory in a text trajectory set. For example, the computing device 104 in FIG. 1 is configured to determine a first text feature set of a first text set in a target frame of the video 102 and a second feature set of a second text set in a plurality of video frames before the target frame.

In some embodiments, when determining the first feature set, the computing device 104 first determines a text region in the target frame. Then, the computing device 104 detects an image feature corresponding to the target frame, and then determines an image feature corresponding to the text region from the image feature. Further, the computing device 104 will also use this part of the image feature to determine a feature corresponding to the text in the text region in the first text set. In an example, the computing device detects the text region and the text feature in the text region by a configured neural network model. In another example, the computing device 104 determines the text region and determines the image feature and the text feature by a mapping relationship between a predetermined text region and an image and between an image feature and a text feature. The above examples are only used to describe the present disclosure, and are not specific limitations to the present disclosure. Those skilled in the art can use any suitable method to determine.

In some embodiments, when determining the second feature set corresponding to the second text set, the computing device 104 first determines a feature of a text associated with each of the plurality of frames before the target frame. Then the computing device 104 generates the second feature set by connecting the features of the texts associated with each of the plurality of frames. Alternatively or additionally, the features of the texts associated with each of the plurality of frames are directly used as the second feature set. The above examples are only used to describe the present disclosure, and are not specific limitations to the present disclosure.

At block 304, a degree of association set is determined based on the first feature set and the second feature set, a degree of association in the degree of association set indicating a probability of a text in the first text set being on the text trajectory in the text trajectory set. For example, the computing device 104 determines the degree of association set indicating the probability of the text in the target frame being on the text trajectory in the text trajectory set according to the first feature set in the target frame and the second feature set obtained from the features in the global feature pool 106.

In some embodiments, for ease of description, the degree of association set is also referred to as a first degree of association set. When determining the degree of association set, the computing device first calculates the degree of association between the text in the first text set and the text in the second text set by using the first feature set and the second feature set, to generate a second degree of association set. The degree of association in the second degree of association set indicates the similarity between the text in the first text set and the text in the second text set. Then the computing device 104 determines the first degree of association set according to the second degree of association set and the text trajectory set. In an example, when determining the second degree of association set, the computing device determines a third feature set according to an association relationship between the second feature set and the texts in the second text set. For example, the computing device inputs the second feature set into an encoder of a Transformer network, and the encoder generates the third feature set according to the association relationship between the texts in the text set. Then the computing device determines the second degree of association set based on the third feature set and the first feature set. For example, the third feature set and the first feature set are input into a decoder of the Transformer network to obtain the second degree of association set.

In some embodiments, the computing device 104 first obtains a predetermined mapping relationship between a feature set and a degree of association, and then searches for a second degree of association set corresponding to the first feature set and the second feature set according to the mapping relationship.

In some embodiments, when determining the first degree of association set, the computing device first selects a first degree of association subset corresponding to a target text in the first text set from the second degree of association set. For example, all degrees of association corresponding to the target text are found from the second degree of association set to form the first degree of association subset. Then the computing device 104 selects a second degree of association subset corresponding to a target text trajectory in the text trajectory set from the first degree of association subset. For example, the computing device 104 searches for a degree of association related to the target trajectory from the first degree of association subset according to the identification of the target trajectory. Then the computing device uses the second degree of association subset to determine the degree of association between the target text and the target text trajectory.

In some embodiments, the degree of association in the second degree of association subset is a probability value. Therefore, when determining the degree of association between the target text and the target text trajectory, the computing device will determine the degree of association between the target text and the target text trajectory by adding the probability values in the second degree of association subset.

In some embodiments, the degree of association in the second degree of association subset is a probability value or an association level. When determining the degree of association between the target text and the target text trajectory, the computing device selects the largest value in the second degree of association subset as the degree of association between the target text and the target text trajectory. The above examples are only used to describe the present disclosure, and are not specific limitations to the present disclosure.

In some embodiments, when determining the second degree of association set according to the first feature set and the second feature set, the computing device determines the second degree of association set by applying a neural network model to the first text set and the second text set, where the neural network model includes an encoder and a decoder. For example, a Transformer neural network model.

Further, the computing device 104 can also train the neural network model. For example, the computing device first determines a sample feature set corresponding to a text set in a plurality of frames in a sample video and a sample degree of association set of the sample feature set with itself. Then the computing device uses the sample feature set as sample inputs to the encoder and the decoder respectively and uses the sample degree of association set as a sample output of the neural network model to train the neural network model.

In some embodiments, the computing device 104 first obtains a predetermined mapping relationship between a feature set and a degree of association, and then searches for a first degree of association set corresponding to the first feature set and the second feature set according to the mapping relationship. The above examples are only used to describe the present disclosure, and are not specific limitations to the present disclosure.

At block 306, a text trajectory corresponding to a text in the first text set is determined based on the degree of association set. For example, the computing device 104 determines the text trajectory corresponding to the text in the first text set according to the degree of association set 112.

In some embodiments, the computing device 104 directly uses the degree of association set to determine the text trajectory corresponding to the text in the first text set. In an example, the Hungarian algorithm is applied to the degree of association set to match the text in the first text set with the text trajectory in the text trajectory set. In another example, a mapping relationship between a text and a text trajectory that is preset according to the degree of association between the text and the text trajectory is first obtained, and then the text trajectory corresponding to the text in the first text set is searched for in the mapping relationship according to the degree of association set.

In some embodiments, when determining the text trajectory corresponding to the text in the first text set, the computing device first determines the similarity between a first bounding box of a first text and a second bounding box of a second text, where the first text is included in the first text set, and the second text is included in the second text set and is located in a previous frame of the target frame. Then the computing device determines the text trajectory corresponding to the text in the first text set based on the degree of association set and the similarity.

In some embodiments, when determining the similarity between the first bounding box of the first text and the second bounding box of the second text, the computing device first determines a first representation indicating a size and a position of the first bounding box and a second representation indicating a size and a position of the second bounding box. For example, the size and position of the bounding box are represented as b(x, y, w, h, θ), x, y represent coordinates of a center point of the bounding box, w represents one side of the bounding box, h represents another side of the bounding box, and θ represents a rotation angle of the bounding box around the X-axis. Then, the computing device can use the first representation and the second representation to determine the similarity between the first bounding box and the second bounding box.

In some embodiments, when determining the similarity between the first bounding box and the second bounding box, the computing device converts the first representation to a first Gaussian distribution, and then converts the second representation to a second Gaussian distribution. Then the computing device determines the similarity according to the first Gaussian distribution and the second Gaussian distribution, for example, calculates a distance between the two Gaussian distributions, and indicates the similarity between the two by the distance, such as Wasserstein distance.

In some embodiments, when determining the similarity between the first bounding box and the second bounding box, the computing device searches for a similarity corresponding to the first representation and the second representation in a mapping relationship between a predetermined representation of a bounding box and a similarity according to the mapping relationship.

In some embodiments, when determining the text trajectory corresponding to the text in the first text set by using the degree of association set and the similarity, the computing device first determines a first degree of association between the text trajectory where the second text is located and the first text from the degree of association set. For example, the computing device searches for the first degree of association corresponding to the text trajectory where the second text is located and the first text from the degree of association set. Then the computing device determines a second degree of association between the text trajectory where the second text is located and the first text based on the similarity and the first degree of association. Finally, the first degree of association in the degree of association set is updated with the second degree of association. For example, the computing device determines a maximum value of the similarity and the second degree of association as the degree of association between the text trajectory and the first text. The computing device uses the updated degree of association set to determine the text trajectory corresponding to the text in the first text set.

In some embodiments, when determining the text trajectory corresponding to the text in the first text set, the computing device may determine the text trajectory corresponding to the text in the first text set by performing a maximum matching on the first text set and the text trajectory set based on the updated degree of association set. For example, the text trajectory corresponding to the text in the first text set is determined by the Hungarian algorithm.

In some embodiments, the computing device performs a video understanding operation on the video according to the text trajectory. In some embodiments, the computing device performs video retrieval according to the text trajectory. In some embodiments, the computing device performs video capturing according to the text trajectory. The above examples are only used to describe the present disclosure, and are not specific limitations to the present disclosure.

Through the above method, the accuracy of text trajectory recognition is improved and the text trajectory switching occurred in the recognition process is reduced by using historical information in the video. In a further improvement, the solution also introduces the similarity of text bounding boxes in two adjacent frames, making the text trajectory prediction more accurate. Moreover, in this solution, text recognition and trajectory prediction are processed separately, making text recognition more comprehensive and improving user experience.

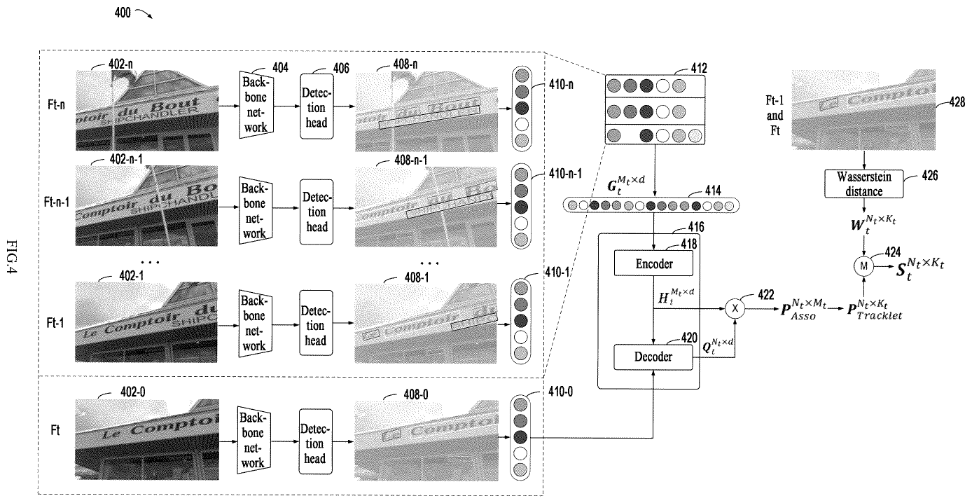

The above describes the schematic diagram of the example method for determining a trajectory of a text in a video according to the embodiment of the present disclosure with reference to FIG. 3. The following describes the schematic diagram of the example framework for determining a trajectory of a text in a video according to the embodiment of the present disclosure with reference to FIG. 4.

As shown in FIG. 4, the example 400 adopts an end-to-end framework for video text recognition, through which global information association and shape-aware information are performed. The entire framework is shown in FIG. 4. The framework includes three parallel heads: a detection head, a recognition head, and a tracking head. Given a video including video frames 402-0, 402-1, . . . , 402-n−1, and 402-n, which may also be referred to as frames Fₜ, Fₜ₋₁, . . . , Fₜ₋ₙ₋₁, Fₜ₋ₙ, where n is a positive integer, the n+1 video frames may be a complete video, or video frames included in a sliding video window in the video. First, each video frame in the video is processed by using the backbone network 404 and the detection head 406 to detect a bounding box corresponding to a text. As shown in FIG. 4, the processed video frames 408-0, 408-1, . . . , 408-n−1, and 408-n include bounding boxes for texts. When a bounding box detected in the frame 402-0 or the frame Fₜ includes a potential text object, a corresponding text feature or a tracking embedding eₜⁱ is extracted for each object, and the tracking embeddings in each frame form feature sets 410-0, 410-1, . . . , 410-n−1, and 410-n. Additionally, a global embedding pool 412 is further provided as [symbol] ₜ, and is configured to store features or tracking embeddings of texts in processed video frames. A concatenation of all embeddings in [symbol] ₜ is represented as Gₜ∈ [symbol] ^{M}^{ₜ}^{×d} 414, where

$${M}_{t} = {\sum }_{i = t - L}^{t - 1} {N}_{i}$$

represents the number of embeddings in [symbol] ₜ. Nₜ is the number of texts in the frame Fₜ, d is the dimension of each embedding, and L is the size of the sliding window.

The tracking head in the framework is configured to calculate association scores between the objects in the frame Ft and the objects in [symbol] ₜ, to generate an association matrix P_{ASSO}∈ [symbol] ^{N}^{ₜ}^{×M}^{ₜ}, and then convert P_{ASSO} to a trajectory-level association matrix represented as P_{Tracklet}∈ [symbol] ^{N}^{ₜ}^{×K}^{ₜ}, where Kₜ is the number of trajectories in the global embedding pool [symbol] ₜ. Additionally, the form similarity between two adjacent frames Fₜ and Fₜ₋₁ 428 also needs to be calculated, and a distance matrix Wₜ∈ [symbol] ^{N}^{ₜ}^{×K}^{ₜ} is output by calculating Wasserstein distance 426. The two score matrices P_{Tracklet} and Wₜ are combined by a simple maximum operation 424 without any other post-processing, and a final score is output to generate Sₜ∈ [symbol] ^{N}^{ₜ}^{×K}^{ₜ} as shown in FIG. 4. A maximum matching algorithm, such as the Hungarian algorithm, is applied to assign text trajectory identifications to the text objects in Fₜ.

For the text feature set in the global embedding pool [symbol] ₜ and the text feature set 410-0, a neural network model is used to process to determine the correlation between texts corresponding to the two feature sets. For example, a Transformer network 416 is used for global tracking. All previous embeddings in the global embedding pool are encoded by the Transformer encoder 416 into historical information or intermediate representations. The Transformer decoder 420 inputs the encoded historical information, and calculates the similarity scores between texts and trajectories in the current frame with the embeddings in the current frame as queries. Further, a multiplication operation 422 is also performed when calculating the similarity scores. The entire process is shown in Formulas (1) and (2):

$${H}_{t} = Encoder ( {G}_{t} ) \qquad ( 1 )$$

$${P}_{A s s o} = Decoder ( {Q}_{t} , {H}_{t} ) {H}_{t}^{T} \qquad ( 2 )$$

where Hₜ∈ [symbol] ^{M}^{ₜ}^{×d} represents the encoded historical information. P_{ASSO}∈ [symbol] ^{N}^{ₜ}^{M}^{ₜ} is the output association matrix. Qₜ∈ [symbol] ^{N}^{ₜ}^{×d} refers to the query embedding (i.e., the embedding of the current frame).

In the training process, all embeddings are associated with themselves (i.e., Qₜ=Gₜ) to generate an association matrix A∈ [symbol] ^{M×M}, where

$$M = {\sum }_{t = 1}^{B} {N}_{t}$$

is the number of all texts in a batch of frames, and B represents the number of frames in a batch of frames, for example, the number may be 16. For each text in each time stamp t, a vector a∈ [symbol] ^{N}^{ₜ}⁺¹ is set, which represents an association score between a query embedding qᵢ and an embedding in the frame Fₜ. The extra dimension in a refers to an empty association (i.e., when there is no matching target in the frame being queried, this usually represents an occlusion or the end of a trajectory). The Softmax function is used in Formula (3) to convert the scores into probabilities P_{ASSO}:

$${P}_{A s s o} ( {q}_{i} , {e}_{j} ) = \frac{exp ( {a}_{j} )}{{\sum }_{j ∈ ( 0 , 1 , … , {N}_{t} )} exp ( {a}_{j} )} \qquad ( 3 )$$

Therefore, the scores are learned by minimizing the log-likelihood of each possibility. For each trajectory set [symbol] ₖ, k=1, 2, . . . , K, assuming that there are Nk embeddings in Tk, for each query embedding eᵢ in the global embedding pool [symbol] , the loss is only calculated when eᵢ∈Tₖ. The loss is shown in Formula (4):

$${ℓ}_{tracklet} ( {𝕋}_{k} , {q}_{i} ) = - {\sum }_{j = 1}^{{N}_{k}} {𝟙}_{{q}_{i} ∈ {T}_{k}} \cdot log {P}_{A s s o} ( {q}_{i} , {e}_{j ,} ) \qquad ( 4 )$$

$${ℓ}_{track} = {\sum }_{k = 1}^{K} {\sum }_{i = 1}^{M} {ℓ}_{trackle𝔱} ( {𝕋}_{k} , {q}_{i} )$$

where if the query embedding belongs to the trajectory set [symbol] ₖ, [symbol] _{q}_{ᵢ}_{∈T}_{ₖ} is 1, otherwise it is 0.

Further, in order to increase the discrimination of embeddings, semantic information is also introduced to improve the tracking performance. Specifically, the embeddings input to the Transformer are extracted by rotated RolAlign with a convolutional layer and a long short-term memory (Long Short-Term Memory, LSTM) layer, followed by a fully connected layer that projects the features into word classes. The architecture is represented by Formula (5):

$${e}_{t} = l s t m ( conv ( r - r o i ( {X}_{t} ) ) ) \qquad ( 5 )$$

$${o}_{t} = f c ( {e}_{t} )$$

where Xₜ is the backbone feature map in the frame Ft, eₜ is the embedding into the Transformer for association, and oₜ is the recognition output supervised by connectionist temporal classification (CTC) loss.

The queries in this solution carry information of each text instance, and perform attention between the queries and the global embeddings to output the association matrix, thereby obtaining a stronger perception of the contextual information. The solution also maintains a global embedding pool, which can be regarded as a queue and has long-range temporal perception. The solution also avoids the detection performance being compromised by competition between two tasks of determining the trajectory and recognizing the text.

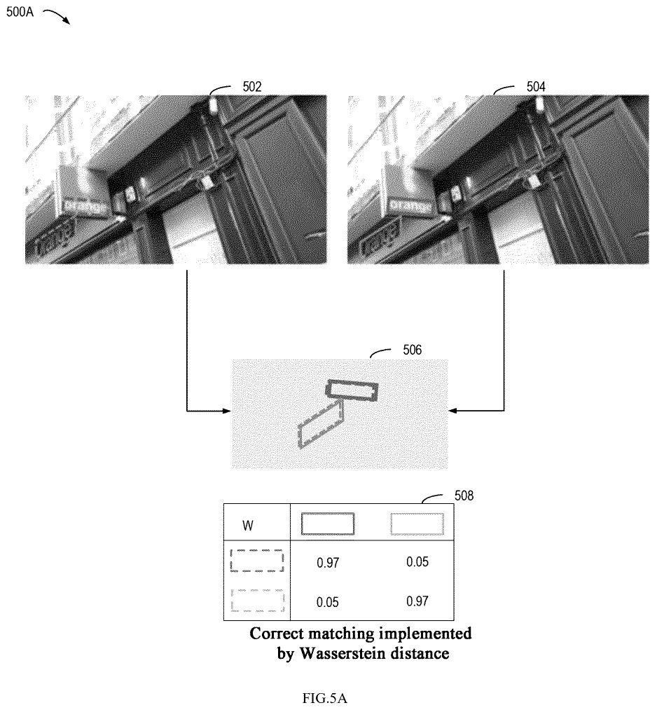

For the form information, Wasserstein distance is used to simulate position similarity and shape similarity. As shown in FIG. 5A-FIG. 5C, which illustrate schematic diagrams of three examples of detecting similarity of text boxes according to an embodiment of the present disclosure, three examples are used to show the recognition of Wasserstein distance. In FIG. 5A, all texts are moving at a low speed, so the position information is sufficient for association, for example, the position and shape of the texts in the video frames 502 and 504 are basically unchanged, and the changes in position and shape are as shown in the box 506. At this time, Wasserstein distance can be correctly matched as shown in the box 508. In FIG. 5B, the fast movement of the camera causes the text to quickly drift. In this case, although the form difference is obvious, the Wasserstein distance can capture the discontinuity. For example, the position and shape of the texts in the video frames 510 and 512 change greatly, and the changes in position and shape are as shown in the box 514. At this time, Wasserstein distance can be correctly matched as shown in the box 516. In FIG. 5C, due to the fast movement of the car, Wasserstein distance can still perform correct position association. For example, the position and shape of the texts in the video frames 518 and 520 change more greatly, and the changes in position and shape are as shown in the box 522. At this time, Wasserstein distance can also be correctly matched as shown in the box 524.

In order to obtain the perception of position and shape as described above, it is necessary to model polygons in different frames into Gaussian distributions, and measure the similarity through distribution distances. For each bounding box in two adjacent frames, the pairwise Wasserstein distance between the corresponding bounding boxes b(x, y, w, h, θ) is calculated. The rotated box b is converted into a Gaussian distribution N(μ, σ) as shown in Formula (6):

$$σ = {RSR}^{T} = ( \begin{matrix}cos θ & - sin θ \\ sin θ & cos θ\end{matrix} ) ( \begin{matrix}\frac{w}{2} & 0 \\ 0 & \frac{h}{2}\end{matrix} ) ( \begin{matrix}cos θ & sin θ \\ - sin θ & cos θ\end{matrix} ) = ( \begin{matrix}\frac{w}{2} {cos}^{2} θ + \frac{h}{2} {sin}^{2} θ & \frac{w - h}{2} cos θ sin θ \\ \frac{w - h}{2} cos θ sin θ & \frac{w}{2} {sin}^{2} θ + \frac{h}{2} {cos}^{2} θ\end{matrix} ) \qquad ( 6 )$$

where R is a rotation matrix, and S is a diagonal matrix. The Wasserstein distance between the two Gaussian distributions is represented by Formula (7):

$${d}^{2} = {‖ {μ}_{1} - {μ}_{2} ‖}_{2}^{2} + {T}_{r} ( {σ}_{1} + {σ}_{2} - 2 {( {σ}_{1}^{1 / 2} {σ}_{2} {σ}_{1}^{1 / 2} )}^{1 / 2} ) \qquad ( 7 )$$

where Tᵣ represents a matrix. In order to utilize the appropriate angle and coordinates, Wasserstein distance can capture position similarity and shape similarity. Finally, in order to convert the distance into an applicable position score, Formula (8) is used:

$$W ( {b}_{1} , {b}_{2} ) = W ( 𝒩 ( {μ}_{1} , {σ}_{1} ) ; 𝒩 ( {μ}_{2} , {σ}_{2} ) ) = 1 - \frac{a d}{f ( {σ}_{1} , {σ}_{2} )} \qquad ( 8 )$$

where α is a hyperparameter, and f is a function for normalizing the distance. ƒ(σ₁, σ₂)=(Tᵣ(σ₁σ₂))^{1/4} is set.

Returning to FIG. 4 for continued description, a loss function is also calculated in the training process. The framework has three tasks and three corresponding losses. For the detection head, the L1 loss is used. For other losses, they are set as needed. For the recognition head, the connectionist temporal classification (Connectionist Temporal classification, CTC) text loss is used. The loss of the entire framework is shown in Formula (9):

$$ℓ = {σ}_{1} {ℓ}_{d e c} + {σ}_{2} {ℓ}_{r e c} + {σ}_{3} {ℓ}_{track} + {e}^{- {σ}_{1}} + {e}^{- {σ}_{2}} + {e}^{- {σ}_{3}} \qquad ( 9 )$$

where σ1, σ2, and σ3 are learnable parameters, and e^{-σ}^{₁}, e^{-σ}^{₂}, and e^{-σ}^{₃} are regularization terms for noise terms.

In the inference process, the trajectories are constructed iteratively. For the initial frame F₀, each text is considered as the beginning of a trajectory. For the frame Fₜ, a global embedding pool [symbol] ₜ is set, which stores all previous embeddings in a sliding window, and the corresponding embedding matrix is written as Gₜ (i.e., connected embeddings). Assuming that there are Kₜ trajectories in [symbol] ₜ, each trajectory has Nₖ embeddings. The embedding matrix in the current frame Fₜ is considered as Qₜ. The association scores Aₜ are calculated between Qₜ and Gₜ, and converted into a probability matrix P_{ASSO} by the Softmax function. Then a trajectory-level sum is applied to calculate the probability of each trajectory. For each qᵢ∈ [symbol] ₜ, it is calculated using Formula (10):

$${P}_{T r a c klet} ( {q}_{i} , {G}_{𝔱} ) = {\sum }_{j = 1}^{{N}_{k}} {P}_{A s s o} ( {q}_{i} , {e}_{j} ) \qquad ( 10 )$$

where eⱼ is the embedding in each trajectory. After calculating all embedding vectors in [symbol] ₜ, a matrix P_{Tracklet}∈ [symbol] ^{N}^{ₜ}^{×K}^{ₜ} is finally obtained, which represents the probability that the embedding vector belongs to the trajectory. Additionally, the Wasserstein distance between the frames Fₜ₋₁ and Fₜ is calculated as the position and shape similarity score Wₜ, and the final output is max (P_{Tracklet}, Wₜ). The Hungarian algorithm is applied to ensure that the ID assignment is unique for each text.

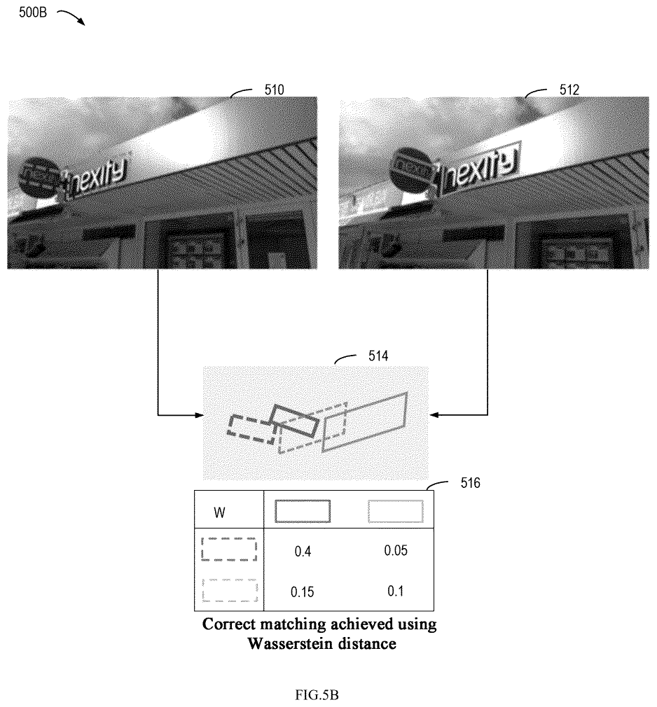

FIG. 6 illustrates a schematic diagram of an example recognition result of a video text according to an embodiment of the present disclosure. In the example 600, in the four video frames 602, 604, 606, and 608 in a video recognized by the solution of the present disclosure, the trajectory of each text in the four video frames is correctly identified without trajectory switching errors, where the bounding boxes of different colors represent different text trajectories in the figure. As shown in the boxes 610, 612, 614, and 616, the texts in the boxes correspond to the same text trajectory.

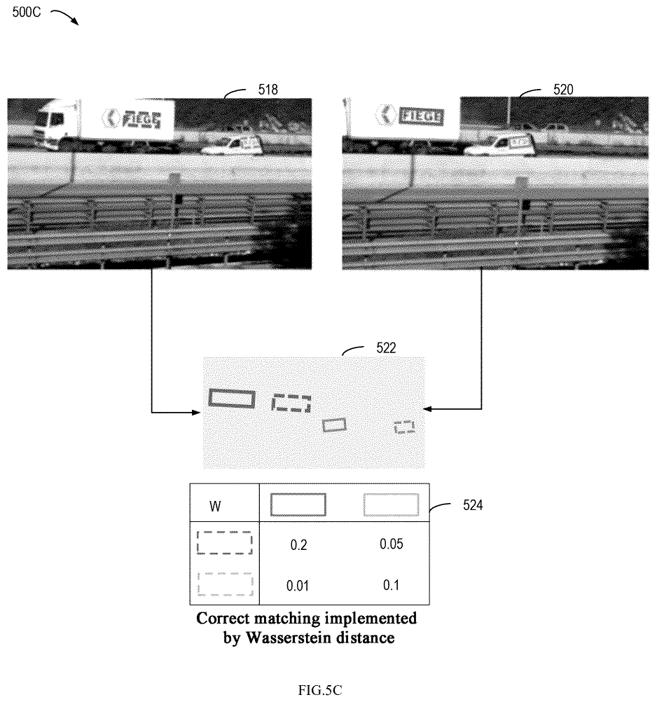

FIG. 7 illustrates a schematic diagram of an example recognition result of a video text according to an embodiment of the present disclosure. In the example 700, two video frames 702 and 704 in the video are processed. Since text recognition and text trajectory confirmation are performed separately, as shown in the two frames, the texts in the pictures are correctly identified.

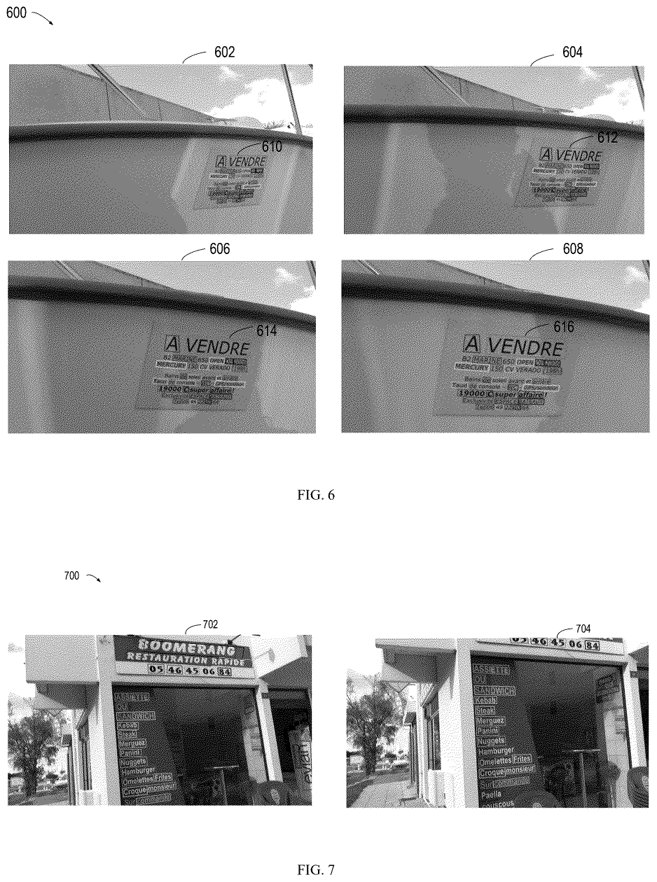

FIG. 8 illustrates a schematic block diagram of an apparatus for determining a trajectory of a text in a video according to an embodiment of the present disclosure. As shown in FIG. 8, the apparatus 800 includes a feature set determination module 802 configured to determine a first feature set corresponding to a first text set and a second feature set corresponding to a second text set, the first text set being located in a target frame of the video, the second text set being located in a plurality of frames before the target frame in the video, and texts in the second text set being associated with a text trajectory in a text trajectory set; a degree of association set determination module 804 configured to determine a degree of association set based on the first feature set and the second feature set, a degree of association in the degree of association set indicating a probability of a text in the first text set being on the text trajectory in the text trajectory set; and a text trajectory determination module 806 configured to determine a text trajectory corresponding to a text in the first text set based on the degree of association set.

In some embodiments, the degree of association set is a first degree of association set, and the degree of association set determination module 804 includes a second degree of association set determination module configured to determine a second degree of association set based on the first feature set and the second feature set, a degree of association in the second degree of association set indicating a similarity between a text in the first text set and a text in the second text set; and a first degree of association set determination module configured to determine the first degree of association set based on the second degree of association set and the text trajectory set.

In some embodiments, the second degree of association set determination module includes a third feature set determination module configured to determine a third feature set based on an association relationship between the second feature set and texts in the second text set; and a feature-based degree of association set determination module configured to determine the second degree of association set based on the third feature set and the first feature set.

In some embodiments, the first degree of association set determination module includes a first degree of association subset determination module configured to select a first degree of association subset corresponding to a target text in the first text set from the second degree of association set; a second degree of association subset determination module configured to select a second degree of association subset corresponding to a target text trajectory in the text trajectory set from the first degree of association subset; and a text-to-trajectory degree of association determination module configured to determine a degree of association between the target text and the target text trajectory based on the second degree of association subset.

In some embodiments, the degree of association in the second degree of association subset is a probability value, and the text-to-trajectory degree of association determination module includes an addition module configured to determine the degree of association between the target text and the target text trajectory by adding probability values in the second degree of association subset.

In some embodiments, the second degree of association set determination module includes a neural network model application module configured to determine the second degree of association set by applying a neural network model to the first text set and the second text set, the neural network model including an encoder and a decoder.

In some embodiments, the apparatus 800 further includes a sample determination module configured to determine a sample feature set corresponding to a text set in a plurality of sample frames in a sample video and a sample degree of association set of the sample feature set with itself; and a training module configured to train the neural network model by using the sample feature set as sample inputs to the encoder and the decoder respectively and using the sample degree of association set as a sample output of the neural network model.

In some embodiments, the text trajectory determination module includes a first similarity determination module configured to determine a similarity between a first bounding box of a first text and a second bounding box of a second text, where the first text is included in the first text set, and the second text is included in the second text set and is located in a previous frame of the target frame; and a first text trajectory determination module configured to determine a text trajectory corresponding to a text in the first text set based on the degree of association set and the similarity.

In some embodiments, the first similarity determination module includes a first representation determination module configured to determine a first representation indicating a size and a position of the first bounding box; a second representation determination module configured to determine a second representation indicating a size and a position of the second bounding box; and a second similarity determination module configured to determine a similarity between the first bounding box and the second bounding box based on the first representation and the second representation.

In some embodiments, the second similarity determination module includes a first Gaussian distribution determination module configured to convert the first representation to a first Gaussian distribution; a second Gaussian distribution determination module configured to convert the second representation to a second Gaussian distribution; and a third similarity determination module configured to determine the similarity based on the first Gaussian distribution and the second Gaussian distribution.

In some embodiments, the first text trajectory determination module includes a first degree of association determination module configured to determine a first degree of association between a text trajectory where the second text is located and the first text from the degree of association set; a second degree of association determination module configured to determine a second degree of association between the text trajectory where the second text is located and the first text based on the similarity and the first degree of association; an update module configured to update the first degree of association in the degree of association set with the second degree of association; and an updated text trajectory determination module configured to determine the text trajectory corresponding to the text in the first text set based on the updated degree of association set.

In some embodiments, the updated text trajectory determination module includes a maximum matching determination module configured to determine the text trajectory corresponding to the text in the first text set by performing a maximum matching on the first text set and the text trajectory set based on the updated degree of association set.

In some embodiments, the feature set determination module 802 includes a text region determination module configured to determine a text region in the target frame; an image feature determination module configured to determine an image feature corresponding to the text region; and a text feature determination module configured to determine a feature corresponding to the text in the text region in the first text set based on the image feature.

In some embodiments, the feature set determination module 802 includes a multi-frame text feature determination module configured to determine a feature of a text associated with each of the plurality of frames; and a second feature set generation module configured to generate the second feature set by connecting the features of the texts associated with each of the plurality of frames.

In some embodiments, the apparatus 800 further includes a video operation unit configured to perform at least one of the following on the video according to the text trajectory: video understanding, video retrieval, or video capturing.

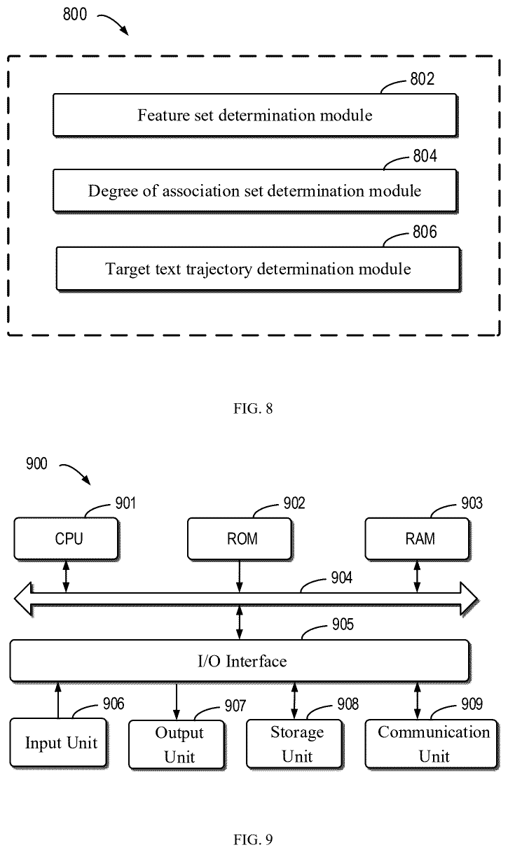

FIG. 9 illustrates a schematic block diagram of an example device 900 that can be used to implement an embodiment of the present disclosure. The computing device 104 in FIG. 1 can be implemented using the device 900. As shown, the device 900 includes a central processing unit (CPU) 901, which can perform various appropriate actions and processing according to computer program instructions stored in a read-only memory (ROM) 902 or computer program instructions loaded from a storage unit 908 into a random access memory (RAM) 903. The RAM 903 can also store various programs and data required for the operation of the device 900. The CPU 901, the ROM 902, and the RAM 903 are connected to each other through a bus 1304. An input/output (I/O) interface 1305 is also connected to the bus 904.

Multiple components in the device 900 are connected to the I/O interface 905, including: an input unit 906, such as a keyboard, a mouse, etc.; an output unit 907, such as various types of displays, speakers, etc.; a storage page 908, such as a magnetic disk, an optical disk, etc.; and a communication unit 909, such as a network card, a modem, a wireless communication transceiver, etc. The communication unit 909 allows the device 900 to exchange information/data with other devices through a computer network such as the Internet and/or various telecommunication networks.

The various processes and processing described above, such as the method 300, may be performed by the processing unit 901. For example, in some embodiments, the method 300 may be implemented as a computer software program, which is tangibly contained in a machine-readable medium, such as the storage unit 908. In some embodiments, parts or all of the computer program may be loaded and/or installed on the device 900 via the ROM 902 and/or the communication unit 909. When the computer program is loaded into the RAM 903 and executed by the CPU 901, one or more actions of the method 300 described above may be executed.

The present disclosure may be a method, an apparatus, a system and/or a computer program product. The computer program product may include a computer-readable storage medium on which computer-readable program instructions for performing various aspects of the present disclosure are loaded.

The computer-readable storage medium may be a tangible device that can hold and store instructions used by the instruction executing device. The computer-readable storage medium may be, for example, but not limited to, an electrical storage device, a magnetic storage device, an optical storage device, an electromagnetic storage device, a semiconductor storage device, or any suitable combination thereof. More specific examples of the computer-readable storage medium (non-exhaustive list) include: portable computer disk, hard disk, random access memory (RAM), read-only memory (ROM), erasable programmable read-only memory (EPROM or flash memory), static random access memory (SRAM), portable compact disk read-only memory (CD-ROM), digital versatile disk (DVD), memory stick, floppy disk, mechanical encoding device, such as punched card or groove protrusion structure on which instructions are stored, and any suitable combination thereof. The computer-readable storage medium used here is not interpreted as the instantaneous signal itself, such as radio waves or other freely propagating electromagnetic waves, electromagnetic waves propagating through waveguides or other transmission media (for example, light pulses through fiber optic cables), or electrical signals transmitted through wires.

The computer-readable program instructions described here may be downloaded from a computer-readable storage medium to each computing/processing device, or downloaded to an external computer or an external storage device via a network, such as the Internet, a local area network, a wide area network, and/or a wireless network. The network may include copper transmission cables, optical fiber transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

The computer program instructions used to perform the operations of the present disclosure may be assembly instructions, instruction set architecture (ISA) instructions, machine instructions, machine-related instructions, microcodes, firmware instructions, status setting data, or source code or target code written in any combination of one or more programming languages, including object-oriented programming languages such as Smalltalk, C++, etc., and conventional procedural programming languages such as “C” language or similar programming languages. The computer-readable program instructions may be executed entirely on the user's computer, executed partly on the user's computer, executed as a stand-alone software package, executed partly on the user's computer and partly on a remote computer, or executed entirely on the remote computer or server. In the case of a remote computer, the remote computer may be connected to the user's computer through any type of network, including a local area network (LAN) or a wide area network (WAN), or may be connected to an external computer (for example, connected via the Internet using an Internet service provider). In some embodiments, the electronic circuit, such as a programmable logic circuit, a field programmable gate array (FPGA), or a programmable logic array (PLA), can be customized by using state information of the computer-readable program instructions, and the electronic circuit can execute the computer-readable program instructions to implement various aspects of the present disclosure.

Various aspects of the present disclosure are described here with reference to flowcharts and/or block diagrams of methods, apparatuses (systems) and computer program products according to embodiments of the present disclosure. It should be understood that each block of the flowcharts and/or block diagrams and combinations of blocks in the flowcharts and/or block diagrams can be implemented by computer-readable program instructions.

These computer-readable program instructions may be provided to a processing unit of a general-purpose computer, a special-purpose computer, or other programmable data processing apparatus, thereby producing a machine, such that the instructions, when executed by the processing unit of the computer or other programmable data processing apparatus, produce an apparatus for implementing the functions/actions specified in one or more blocks of the flowcharts and/or block diagrams. These computer-readable program instructions may also be stored in a computer-readable storage medium, and these instructions cause the computer, the programmable data processing apparatus and/or other devices to work in a specific manner, so that the computer-readable medium storing the instructions includes an article of manufacture, which includes instructions for implementing various aspects of the functions/actions specified in one or more blocks of the flowcharts and/or block diagrams.

The computer-readable program instructions may also be loaded onto a computer, other programmable data processing apparatus or other devices, such that a series of operation steps are executed on the computer, other programmable data processing apparatus or other devices to produce a computer-implemented process, such that the instructions executed on the computer, other programmable data processing apparatus or other devices implement the functions/actions specified in one or more blocks of the flowcharts and/or block diagrams.

The flowcharts and block diagrams in the drawings show possible implementations of architectures, functions and operations of the system, method and computer program product according to multiple embodiments of the present disclosure. In this regard, each block in the flowcharts or block diagrams may represent a module, a program segment, or a part of instructions, the module, program segment, or part of instructions including one or more executable instructions for implementing specified logical functions. In some alternative implementations, the functions noted in the blocks may also occur in a different order from the order noted in the drawings. For example, two consecutive blocks may, in fact, be executed substantially in parallel, or the two consecutive blocks may sometimes be executed in a reverse order, depending on the functions involved. It should also be noted that each block of the block diagrams and/or flowcharts and combinations of blocks in the block diagrams and/or flowcharts may be implemented by a dedicated hardware-based system that performs the specified functions or actions, or may be implemented by a combination of dedicated hardware and computer instructions.

The embodiments of the present disclosure have been described above, and the above description is exemplary, not exhaustive, and is not limited to the disclosed embodiments. Many modifications and changes will be apparent to those of ordinary skill in the art without departing from the scope and spirit of the described embodiments. The selection of terms used herein is intended to best explain the principles, practical applications or technical improvements of the technology in the market of the embodiments, or to enable other ordinary skilled in the art to understand the embodiments disclosed herein.

1. A method for determining a trajectory of a text in a video, comprising:
determining a first feature set corresponding to a first text set and a second feature set corresponding to a second text set, the first text set being located in a target frame of the video, the second text set being located in a plurality of frames preceding the target frame in the video, and a text in the second text set being associated with a text trajectory in a text trajectory set;
determining a degree of association set based on the first feature set and the second feature set, a degree of association in the degree of association set indicating a probability of a text in the first text set being on the text trajectory in the text trajectory set; and
determining a text trajectory corresponding to the text in the first text set based on the degree of association set.

2. The method according to claim 1, wherein the degree of association set is a first degree of association set, wherein the determining the degree of association set comprises:
determining a second degree of association set based on the first feature set and the second feature set, a degree of association in the second degree of association set indicating a similarity between the text in the first text set and a text in the second text set; and
determining the first degree of association set based on the second degree of association set and the text trajectory set.

3. The method according to claim 2, wherein determining the second degree of association set comprises:
determining a third feature set based on an association relationship between the second feature set and the text in the second text set; and
determining the second degree of association set based on the third feature set and the first feature set.

4. The method according to claim 2, wherein determining the first degree of association set comprises:
selecting a first degree of association subset corresponding to a target text in the first text set from the second degree of association set;
selecting a second degree of association subset corresponding to a target text trajectory in the text trajectory set from the first degree of association subset; and
determining a degree of association between the target text and the target text trajectory based on the second degree of association subset.

5. The method according to claim 4, wherein the degree of association in the second degree of association subset is a probability value, wherein the determining the degree of association between the target text and the target text trajectory comprises:
determining the degree of association between the target text and the target text trajectory by adding probability values in the second degree of association subset.

6. The method according to claim 2, wherein determining the second degree of association set based on the first feature set and the second feature set comprises:
determining the second degree of association set by applying a neural network model to the first text set and the second text set, the neural network model comprising an encoder and a decoder.

7. The method according to claim 6, further comprising:
determining a sample feature set corresponding to a text set of a plurality of sample frames in a sample video and a sample degree of association set of the sample feature set with the sample feature set; and
training the neural network model by using the sample feature set as sample inputs to the encoder and the decoder respectively and using the sample degree of association set as a sample output of the neural network model.

8. The method according to claim 1, wherein determining the text trajectory corresponding to the text in the first text set comprises:
determining a similarity between a first bounding box of a first text and a second bounding box of a second text, the first text being comprised in the first text set, and the second text being comprised in the second text set and being located in a previous frame of the target frame; and
determining the text trajectory corresponding to the text in the first text set based on the degree of association set and the similarity.

9. The method according to claim 8, wherein determining the similarity between the first bounding box of the first text and the second bounding box of the second text comprises:
determining a first representation indicating a size of the first bounding box and a position of the first bounding box;
determining a second representation indicating a size of the second bounding box and a position of the second bounding box; and
determining the similarity between the first bounding box and the second bounding box based on the first representation and the second representation.

10. The method according to claim 9, wherein determining the similarity between the first bounding box and the second bounding box comprises:
converting the first representation to a first Gaussian distribution;
converting the second representation to a second Gaussian distribution; and
determining the similarity based on the first Gaussian distribution and the second Gaussian distribution.

11. The method according to claim 8, wherein determining the text trajectory corresponding to the text in the first text set based on the degree of association set and the similarity comprises:
determining a first degree of association between the text trajectory where the second text is located and the first text from the degree of association set;
determining a second degree of association between the text trajectory where the second text is located and the first text based on the similarity and the first degree of association;
updating the first degree of association in the degree of association set with the second degree of association; and
determining the text trajectory corresponding to the text in the first text set based on the updated degree of association set.

12. The method according to claim 11, wherein determining the text trajectory corresponding to the text in the first text set based on the updated degree of association set comprises:
determining the text trajectory corresponding to the text in the first text set by performing a maximum matching on the first text set and the text trajectory set based on the updated degree of association set.

13. The method according to claim 1, wherein determining the first feature set corresponding to the first text set comprises:
determining a text area in the target frame;
determining an image feature corresponding to the text area; and
determining a feature corresponding to the text in the text area in the first text set based on the image feature.

14. The method according to claim 1, wherein determining the second feature set corresponding to the second text set comprises:
determining a feature of a text associated with each of the plurality of frames; and
generating the second feature set by connecting features of texts associated with each of the plurality of frames.

15. The method according to claim 1, further comprising:
performing at least one of the following on the video based on the text trajectory: video understanding, video retrieval, or video capturing.

16. (canceled)

17. An electronic device, comprising:
at least one processor; and
a storage apparatus, configured to store at least one program, wherein the at least one program, when executed by the at least one processor, causes the device to:
determine a first feature set corresponding to a first text set and a second feature set corresponding to a second text set, the first text set being located in a target frame of the video, the second text set being located in a plurality of frames preceding the target frame in the video, and a text in the second text set being associated with a text trajectory in a text trajectory set;
determine a degree of association set based on the first feature set and the second feature set, a degree of association in the degree of association set indicating a probability of a text in the first text set being on the text trajectory in the text trajectory set; and
determine a text trajectory corresponding to the text in the first text set based on the degree of association set.

18. A non-transitory computer-readable storage medium, having a computer program stored thereon, wherein the computer program, when executed by a processor, cause the processor to:
determine a first feature set corresponding to a first text set and a second feature set corresponding to a second text set, the first text set being located in a target frame of the video, the second text set being located in a plurality of frames preceding the target frame in the video, and a text in the second text set being associated with a text trajectory in a text trajectory set;
determine a degree of association set based on the first feature set and the second feature set, a degree of association in the degree of association set indicating a probability of a text in the first text set being on the text trajectory in the text trajectory set; and
determine a text trajectory corresponding to the text in the first text set based on the degree of association set.

19. The electronic device according to claim 17, wherein the degree of association set is a first degree of association set, wherein the processor causing the device to determine the degree of association set further causes the device to:
determine a second degree of association set based on the first feature set and the second feature set, a degree of association in the second degree of association set indicating a similarity between the text in the first text set and a text in the second text set; and
determine the first degree of association set based on the second degree of association set and the text trajectory set.

20. The electronic device according to claim 17, wherein the processor causing the device to determine the text trajectory corresponding to the text in the first text set further causes the device to:
determine a similarity between a first bounding box of a first text and a second bounding box of a second text, the first text being comprised in the first text set, and the second text being comprised in the second text set and being located in a previous frame of the target frame; and
determine the text trajectory corresponding to the text in the first text set based on the degree of association set and the similarity.

21. The electronic device according to claim 17, wherein the processor causing the device to determine the second feature set corresponding to the second text set further causes the device to:
determine a feature of a text associated with each of the plurality of frames; and
generate the second feature set by connecting features of texts associated with each of the plurality of frames.
